(19) United States
(12) Patent Application Publication
(10) Pub. No.: US 2013/0006795 A1
(43) Pub. Date: Jan. 3, 2013

(54) INTERNET BASED FORUM ALLOWING INDIVIDUAL CONSUMERS TO POOL THEIR BUYING POWER

(76) Inventor: Allen Kahn, Passaic, NJ (US)

(21) Appl. No.: 13/537,035

(22) Filed: Jun. 28, 2012

Related U.S. Application Data
(66) Substitute for application No. 61/503,613, filed on Jul. 1, 2011.

(51) Int. Cl. G06Q 30/06

(52) U.S. Cl. 705/26.2

(57) ABSTRACT

The invention relates to a method of realizing volume saving for consumers through the use of a web based system. In the claimed method at least one consumer and at least one supplier registers in a web based medium. Each is dynamically presented with a technological environment that is customized to perform at least one consumer task or at least one supplier task. The at least one consumer utilizes the technological environment to express an interest to enter into at least one consumer transaction, and to subordinate or subject this consumer transaction to at least one prerequisite condition. The disclosed technological environment also enables the at least one supplier to list at least one supplying transaction and subject such transaction to a perquisite condition or to a prerequisite minimum quantity condition. The present invention also discloses a mediator step, which is responsible for facilitating the meeting of the minds between at least one consumer an the at least one supplier.

### CLAIM OF PRIORITY

This application claims prior of a U.S. Patent No. 61/503,613 filed on Jul. 1, 2011, the contents of which are fully incorporated herein by reference.

### FIELD OF THE INVENTION

The present invention relates generally to consumer buying power websites and more specifically it relates to an internet based forum allowing individual consumers to pool their buying power for providing individual buyers (consumers) an online forum whereby individual users can combine their buying power with other buyers to obtain volume pricing discounts for various products, while only having to individually purchase a single or small quantity of units.

### BACKGROUND OF THE INVENTION

The advent of computers connected together by one uninterrupted network, the internet, has proven to be a boon for consumerism and for other mercantile interests. It has vastly improved and streamlined the way business deals are sought, negotiated and executed. Consumers and suppliers are no longer limited by geographic, sovereign and language barriers, as these barriers are, for the most part, irrelevant on the web.

While the barriers have been eliminated, other cornerstone facts of the mercantile world remain the same. One such fact is that wholesalers and dealers in bulk usually get a big price break over retail, single item customers. This has been a fact for millennia, and remains the primary means of how merchants earn their profit. This is true even on the web. A single consumer will pay a premium for purchasing small lots of goods or services. The present invention aims to level the playing field somewhat by uniting individuals into a single purchasing power, capable of tapping into the benefits of bulk discounts.

This business method is a novel implementation of an old concept in consumer economics: consumers have more leverage to obtain favorable product pricing when products are purchased in large quantities. While the Internet has brought innumerable changes in the way our consumer economy operates, the individual consumer has not yet reaped the direct benefits of large quantity pricing.

This business method is a concept that will bring thousands of individual buyers to a single web portal where they will be able to combine their individual buying power to collectively purchase products in large quantities, and realize heretofore unobtainable savings. Members of the online community created by this method will be able to further increase their buying power and price leveraging capability by networking with existing “friends” and contacts in their existing online social networks, such as FaceBook® and Twitter®.

On the seller side of this business method will be a network of product suppliers, competing with one another for offerings of sought after products in large quantities, providing them with the ability to move more product than they would otherwise move.

Product offers will be time limited, and as buyers are putting in requests (acceptances) of a particular order, they will receive periodic notifications as the number of buyer acceptances starts accumulating towards an offer's required quantity target. These notifications will encourage buyers to contact their social networks in order to increase buyer acceptances (and increase the buyer community size) and reach the quantity level, as well as trying to reach the next quantity level, which will result in a lower purchase price for the buyers who are participating in the offer.

Upon becoming a member of the online community created by this business method, the buyer will have access to the Buyer's portal. Within this portal, buyer will have access to current offerings, ability to scan offerings, submit requests for products the buyer would like to see offered, and other account information, such as payment options and information, account funding options, order history, accepted offerings status, ability to send offering information to non-members, customer support contact information, as well as other information that may be necessary for the buyer's interface to allow proper conceptual functioning.

Sellers who are part of the online community created by this method will have access to the Seller's portal. Within this portal, the seller will have access to items for which buyers have shown an interest. Seller will be able to compete with other sellers in order to become the chosen supplier for a particular offering by submitting selling prices and quantity levels for those prices. The information provided to the seller about each offering will include the bid due date, the length of the offering, and minimum quantity. In addition to being able to browse and bid on existing offers, sellers will be able to initiate an offering by submitting a particular item for sale, with pricing for each level of quantity. Such seller initiated offerings will then become available for acceptance by the buyers. Other information available to seller within this portal include account information, such as payment receipt and information, pending offerings and bids, items sold and orders which seller must fulfill, customer support contact information, as well as other information that may be necessary for the sellers' interface to allow proper conceptual functioning.

The Offering.

Product offerings will generally originate from one of two sources: Buyer initiated or Seller initiated. Buyer initiated offerings will be generated as buyers start submitting requests for items they would like to purchase. The web based “back-end” application will monitor and tabulate these requests, and once particular specific items, or general item types (eg: portable DVD player) start receiving multiple requests, an offering bid request will be generated, and appear on the sellers' portal, as well as a notification going out to all sellers. The offering bidding by sellers will be opened for a specific period of time, and after the close of that time, the Offering will then be posted on the buyer's portal, and all buyers that submitted requests for the particular item being offered will be sent a notification. The offering will be open for a specific period of time during which buyers can commit to purchasing an item in the offering, and notify their friends via social networking, encouraging them to commit to the offering as well. Upon closure of the offering, the final price charged to the buyers will be based upon the aggregate quantity purchased and the offered price for that quantity level. The amount of the purchase will be put on ‘hold’ from the buyer's finance account. The winning seller (in a single offer, there may be different sellers that have won the bid for a specific quantity level. For example, Seller ‘A’ may have won the bid for a quantity of 100, but seller ‘B’ won the bid for a quantity of 500. If 200 units were committed to by the buyers, then Seller ‘A’ has won the sale) will be notified of the closed offer and will be sent the offer information, including buyer shipping addresses. Upon shipment of the orders, seller will receive payment (less commission), and the buyer's account will be fully charged.

The Seller initiated offering will operate similarly to the Buyer initiated offer with the exception that the seller's offer will be posted directly to the buyer's portal, without going through the bidding process. This will give buyers an edge if they initiate an offering, and will encourage offerings to greatly increase in number.

The preceding discussion placed the present invention in the context of a buyer and a seller marketplace. However, the present invention can also be applied to a wide range or circumstances. Therefore, the terms buyers and sellers are to be used interchangeably with the terms consumers and suppliers.

### BRIEF DESCRIPTION OF THE RELATED ART

U.S. Pat. No. 7,363,246 discloses a method that enables buyers and sellers to communicate with each other and to negotiate the purchase terms of featured merchandise in a group-buying opportunity. Sellers and buyers may use various forms of on-line group-buying mechanisms in conjunction with the negotiation features of the invention. Buyers may send various inquiries to sellers regarding merchandise offered for sale through the on-line group-buying sale.

U.S. Pat. No. 7,822,648 teaches processing product selections by a plurality of consumers operating one or more web browsers, comprising collecting electronic information, including product identifying information, about the product selections by each consumer of the plurality of consumers, the product selections selected by the plurality of consumers from offerings at a plurality of disparate websites, associating information related to a consumer identified with a particular product selection with the product identifying information, and for associating the product identifying information with a Universal Product Code (UPC) for the product selections.

US Pat. App. 2009/0240629 teaches a system and method for reducing the distance of the understanding and expectation between a buyer and seller for a price of a particular product that is offered for sale. The system and method permit buyer to use their volume purchase power to lower the price of demanded product, and pay only the fair market value of the product in that the price is much lower than the price expectation or requirement of the buyer. Conversely, the system and method permit sellers to reach a targeted market in which a group of buyers are available for desired product.

Various implements are known in the art, but fail to address all of the problems solved by the invention described herein. One embodiment of this invention is illustrated in the accompanying drawings and will be described in more detail herein below.

### SUMMARY OF THE INVENTION

The invention generally relates to a consumer buying power website which includes a web based buyers' portal, a web based sellers' portal and a back-end infrastructure consisting of software and hardware, all based on innovative application of existing and novel technologies, necessary to integrate the portals into a system capable of enabling the invention described herein.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide an internet based forum allowing individual consumers to pool their buying power for providing individual buyers (consumers) an online forum whereby individual users can combine their buying power with other buyers to obtain volume pricing discounts for various products, while only having to individually purchase a single or small quantity of units.

Another object is to provide an Internet Based Forum Allowing Individual Consumers To Pool Their Buying Power that will bring thousands of individual consumers to a single web portal where they will be able to combine their individual buying power to collectively purchase products in large quantities, and realize heretofore unobtainable savings.

Another object is to provide an Internet Based Forum Allowing Individual Consumers To Pool Their Buying Power that will create a network of product suppliers, competing with one another for offerings of sought after products in large quantities, providing them with the ability to move more product than they would otherwise move.

Other objects and advantages of the present invention will become obvious to the reader and it is intended that these objects and advantages are within the scope of the present invention. To the accomplishment of the above and related objects, this invention may be embodied in the form illustrated in the accompanying drawings.

### BRIEF DESCRIPTION OF THE DRAWINGS

FIGS. 1, 2, and 3 are flow diagrams, demonstrating the various method steps.

FIG. 4 is a topographical diagram illustrating the layout of the transactional apparatus.

FIGS. 5, 6, 7A, 7B, 7C, 8A, 8B, 8C, 9A, 9B, 9C, 10A, 10B, 10C, 10D, 10E, 11, 12A, and 12B are a series of screen shots that illustrate and demonstrate the preferred embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Turning now descriptively to the drawings, in which similar reference characters denote similar elements throughout the several views, the figures illustrate a web based buyers' portal, a web based sellers' portal and a back-end infrastructure consisting of software and hardware that is necessary to integrate the portals into a system capable enabling the present invention.

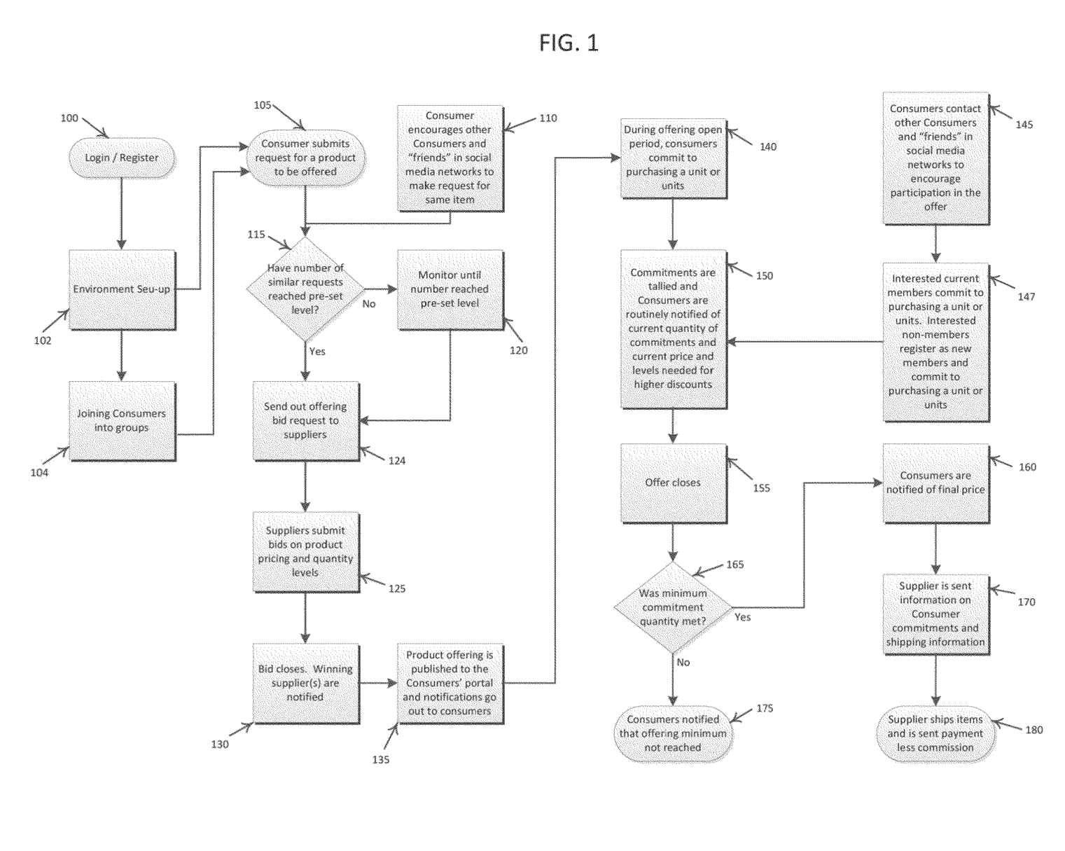

The present invention may be initiated by the consumer or by the supplier, or independently by at least one consumer and at least one supplier. FIG. 1 describes a transaction, or transactional process, that is initiated by at least one consumer. The method claimed in the present invention is preferably conducted within a web based medium. However, the same method can be applied to any other circumstance, such as a traditional brick and mortar mercantile exchange or an auction house.

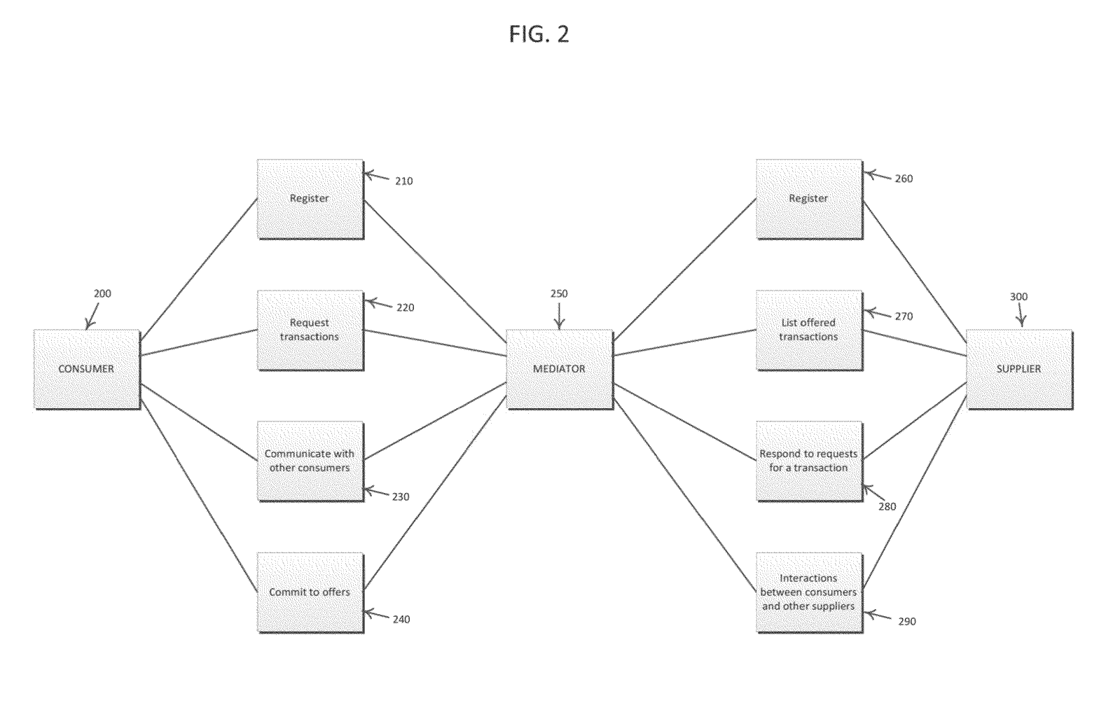

The first of the tasks initiated by the consumer is to submit a request for a product to be offered in step 105. When submitting the request in step 105, the consumer is essentially offering to enter into a transaction involving the product or service requested. The product may be anything bought, sold, traded, leased, rented, or otherwise transacted between two or more parties. The preferred embodiment described in this invention is a marketplace for consumer goods. However, one skilled in the art will appreciate that the claimed invention may be applied to any other kind of market involving at least one consumer of goods or services and at least one supplier of goods or services. Note that it is preferred that a first time consumer begins the process by logging in and registering in step 100. Registration provides the consumer with the necessary technological environment 102. In some embodiments, the mediator (FIG. 2) will suggest, or take the initiative, of grouping consumers with similar tastes, requests or geographic locations, or any other type of criteria, into consumer groups 103. Each consumer so joined may request to have transaction requests and commitments 140 be entered on behalf of the group, or may request a transaction or submit a commitment as an individual.

To increase the appeal of the request submitted in step 105, the at least one consumer will need to proceed to step 110, to encourage his buddies to join him or her in submitting the request. The term buddy in the present invention shall mean anyone interested in the product or service that the at least one consumer requested in step 105. Therefore, buddy can be, but is not limited to a friend, an acquaintance, a business associate, an individual who may share a common association in a social website or a social network in which this consumer or supplier participates, or just a complete stranger who agrees to cooperate with this consumer for just this one transaction. The buddies may already be present in the web based medium as registered consumers or registered suppliers. The buddies may also be reached through interfacing functionality between the web based medium and commonly known social websites, such as Facebook® or Twitter®, or other similar sites.

Next it is determined whether the required prerequisite minimum amount has been reached 115. The consumer can specify prerequisite conditions for completing the proposed consumer transaction. The prerequisite conditions may be, but are not limited to a quantity factor, a transaction term, a delivery term, a transaction type, or any combination of these factors. Similarly, the supplier can propose similar conditions as prerequisites to agreeing to consumer initiated transactions. The most prevalent prerequisite condition for the consumer is the type of item or service, the maximum price for such item or service and the desired quality. As a result, the supplier's prevalent prerequisite condition is the prerequisite minimum quantity.

Both the consumer and the supplier may set prerequisite conditions independently and irrespective of any conditions set by any other party to the transaction. It is highly preferred however that the prerequisite conditions set by, or agreed to by, one consumer will be equally applicable to all other consumers joining transactions initiated by this consumer and that there will not be individual prerequisite conditions. In an alternative embodiment, individual consumers may set their own conditions, if any, or agree to those conditions set by other consumers. In FIG. 1 the supplier has set a prerequisite minimum quantity condition in step 115, and it is up to the consumers participating in this transaction to find additional consumers to join with them, if this prerequisite minimum quantity has not yet been met.

An example of the mediator step of the present invention is demonstrated in step 120. In step 120, the number of subscribing consumers to a given transaction is monitored until it rises to the point where the minimum prerequisite quantity condition is satisfied. The ongoing monitoring and calculation process required in item 120 can be accomplished using intelligent, but automated computer processes.

The monitoring in step 120 may also be achieved using a human mediator. Utilizing a human mediator provides greater flexibility, as the mediator need not abide by the rigid rules of logic spelled out in a computer program. On the other hand, an automated mediator will make faster, more uniform decisions than its human counterpart. As will be demonstrated further, the present invention combines these two types of mediators, as the human mediator is supplied by the web based medium with tools to monitor the type and legitimacy of the transaction.

Once a sufficient number of consumers express interest in a particular transaction 124, the transaction proposal is then presented to at least one supplier or seller for bidding 125. This presentment to the sellers can also take place immediately after step 110. In that case, the at least one supplier or seller will factor in any prerequisite condition of the consumer into the minimum quantity of commitments that will be required for the transaction in step 105. The benefit of an early presentment to the seller is that item 110 is skipped and the additional buddies will be contacted only when a definite commitment is required in step 140. The benefit of 110 is that the consumer would not be limited by any time limit, as time limits are preferably applicable only to seller bidding 130 and consumer commitments 140.

The sellers bid in step 130. The winning bid will be one that exactly matches or one that is the closest and within an accepted range to the prerequisite conditions set by the consumer. The party to the transaction that specified the precondition can also be given an ability to set accepted range of deviation from this precondition. The mediator step, either through a human operator or through computer logic, will determine the winning bid. During supplier bidding and any time prior to this step, the suppliers may be able to form groups of suppliers. Supplier groups may be desired and encouraged by the mediator, if no single supplier can satisfactorily fulfill all prerequisite consumer conditions.

Once the bid closes, the consumers are presented with the winning bid and are requested to commit in step 140. As in step 110, the consumers or buyers may reach out to buddies or other consumers in step 145 with a request to express commitment to the given transaction. Step 145 may be necessary if suppliers raised the minimum quantity of orders on goods or services because, for example, there may have been few bidding suppliers, or the consumers requested a low price, or due to any other foreseen or incidental factors. Previously nonparticipating consumers who begin to search for a desired transaction which matches the current offer may join with the participating consumers, rather than initiating the process from the beginning in step 105. Such consumers may be able to join the proposed transaction any time between steps 105 through 145.

In step 147 the buddies that have joined the ongoing transaction in steps 110 or 145, either by responding to invitation or on their own, are now requested to register, if they have not previously registered. The registration is part of the preferred embodiment of the present invention. Alternatively the buddies may premise their participation in this particular transaction on the user account of the consumer or the supplier who invited them to join.

Once the final number of commitments is tallied in step 150, the offer closes in step 155. The offer may also close if the time limit allotted for this transaction expires. While the time limit is optional it is highly desired. If the required number of commitments meets the prerequisite minimum quantity set by the supplier, the buyer or consumer is notified of the final price in step 160. The buyer's information along with payment information is sent to the winning seller or supplier in step 170, and the transaction ends with the supplier delivering the goods or services in exchange for consideration 180. If the number of commitments falls short of the required minimum, step 165, the transaction is terminated or suspended in step 175, and the buyers or consumers are notified that the transaction will not be moving forward.

FIG. 2 breaks down the role of the mediator step 250. The most essential function of the mediator step 250 is to facilitate the success of the supplying or consuming transactions, and to streamline the operation of the web based medium described in the present invention. A supplying transaction is a transaction initiated by a supplier, a consuming transaction is a transaction initiated by a consumer. The at least one consumer logs into the web based medium 200. If this is the consumer's first access attempt, the web based medium requests registration in step 210. In an alternative embodiment the mediator may, in a separate step, check whether this consumer should be blocked based on prior negative behavior, such as fraud or non-payment, or any ongoing activity, and may block or cancel registration of this consumer. Similarly, the at least one supplier enters the web based medium in step 300 and will be requested to register in step 260, if it is the first such entry. Also, as in the case of the consumers, the mediator confirms whether this seller should be blocked from entering because of prior deleterious or illegal activity.

The registration steps 210 and 260 determine what type of technological environment needs to be supplied upon successful registration. As mentioned above, the registration may be made optional if the user's participation or presence on the web based medium was the result of an invitation by a registered consumer, or supplier.

The consumer can canyon all consumer tasks within the web based medium. The tasks are visible to the mediator who, based on these tasks, may step in and suggest a different type of a transaction or an existing transaction, or to join particular consumers with particular suppliers, or to form groups of consumers or suppliers. The mediator may also be capable of rating whether the requested or listed transaction is likely to be accepted, and may suggest modifications to transaction terms. For example, the consumer can request a consumer transaction in step 220 or the supplier can list a supplying transaction in step 270. These requests are then sent to the mediator step 250. At the mediator step 250 the transactions may be analyzed for viability or legitimacy. The mediator may suggest terms that are more likely be accepted by the other party. For the purposes of the present invention, all actions, also known as transactional activities, taken by a party to the transaction, may constitute part of the transaction if they are undertaken in furtherance of the transaction. Other steps that preferably interact with the mediator step 250 is the communication with other consumers, sellers, or buddies in steps 230 and 290, as well as soliciting bids from suppliers in step 280 and requesting commitments from consumers in step 240.

Still referring to FIG. 2, the mediator step 250 may impose a time limit, also known as a duration limit, on the consumer in steps 220-230 or on the bidding sellers in steps 270-290. If the time limit expires before the prerequisite condition is met, the proposed transaction will be suspended or canceled. Alternatively, there may be a way to extend the time limit, if parties agree, or in exchange to either consumer or the supplier modifying their prerequisite conditions in a manner that will encourage agreement between parties.

The bid selection preferably takes place in the mediator step 250. As described in FIG. 1, the winner is determined in large part on the closeness of the bid to the desired prerequisite conditions of the consumer. If only supplier's preconditions exist or if both suppliers and consumers are permitted to introduce preconditions, then the winner may be determined according to the party having a precondition or according to the weight of the preconditions. These conditions may be set in steps 220, 270 or 280. Unlike prior art, the mediator also takes into account secondary factors and is able to make decisions that maximize savings for the consumer and increase transactional volume for the supplier. Such secondary factors may include, but are not limited to, dependability or track record of the bidder, or satisfaction rate of the bidder with respect to the specific good, or any other secondary factor which may be considered important to the success of the transaction. In the present invention prerequisite conditions for both consuming transaction and supplying transaction may be, but are not limited to a group comprising a maximum price, a quantity factor, a method of payment, a transaction term, a delivery term, a transaction type, a secondary factor or any combination thereof.

The mediator step 250 also has the flexibility to distribute the bid among several suppliers. For example, if in a hypothetical case the minimum prerequisite quantity of orders was set to 500, but there was no seller of the entire lot willing to precisely meet consumers conditions. The mediator will then have the discretion to select one seller for orders from 1-200 and a different supplier for orders from 201-300, if such an arrangement would be more in line with consumer conditions than one winning bid for the entire lot.

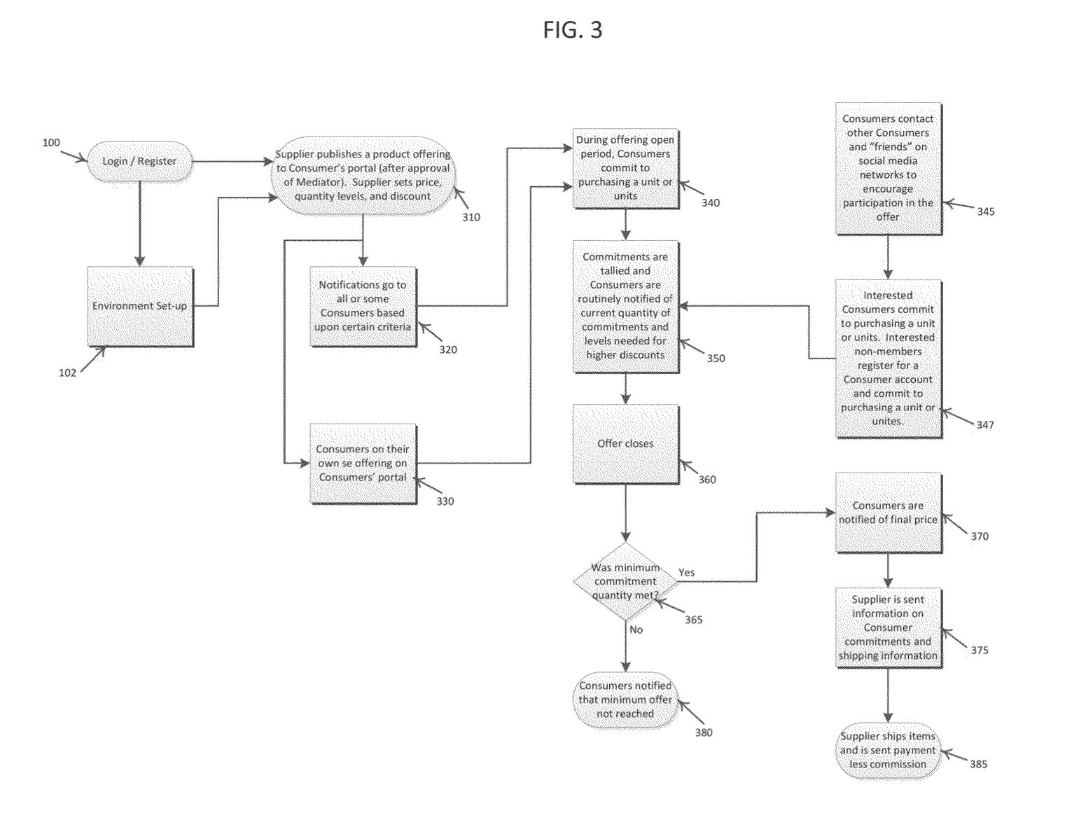

FIG. 3 is somewhat of a mirror image of FIG. 1, except in this figure the supplier or seller initiates the transaction step 310. The seller or supplier is able to list goods or services available, as well as the price at which they are offered. The supplier also specifies the discount rate of the list price. The discount rate is inversely proportional to the number of consumer orders on this particular good or service. Alternatively, the supplier may stratify listed transactions into separate bundles based on the number of orders in each bundle. Each such level representing a number or a bundle of goods or services purchased together. The bigger the number or the bundle, the lower the price is for each individual good or service within the bundle.

The mediator in step 250 (FIG. 2) will see this listing and will suggest it to prospective consumers or consumer groups in 320, who have shown interest in the same or similar transaction by either searching for a similar transaction or by submitting a request for a similar transaction. The mediator will consider a transaction to be similar if it refers to similar goods, services or prerequisite conditions. The seller or supplier may also seek out potential consumers without suggestions from the mediator. In step 330, any transaction listed on the web based medium by the at least one supplier may also passively attract consumers who are actively seeking such a transaction.

A seller's initiated transaction listing 310 would preferably contain all prerequisite conditions required by this seller, such as but not limited to, the minimum quantity, the price at that quantity and the price at larger quantities. It may also contain secondary conditions, such as shipping, quality and method of payment. Therefore, when such an offer is submitted to consumers or buyers in step 340, they join such a transaction by committing to a number of units or types of services indentified by the listed transaction.

At this time consumers may contact their buddies in step 345 and suggest this transaction to them. Consumers have a direct interest in doing so, since it makes consummation of the transaction more likely by helping achieve the preconditions set by the supplier. This preferably leads to step 347, where the buddies who are thus attracted to this transaction can submit their own commitments. As stated in FIG. 1, it is preferable that the buddies are required to register as consumers on the web based medium, as a prerequisite to placing their commitments. Alternatively, they may base their activities under the registration umbrella of the consumer who issued the invitation or suggestion.

In step 350 the commitments are tallied. The tally may be carried out by the mediator step 250 (FIG. 2) or by an automated process running on the web based medium. Step 350 may be running continuously or may be running at random times to show the level of commitments versus the required minimum of such commitments and versus any unexpired time limit. As will be demonstrated in figures below, the web based medium displays the tally to all participants for this transaction to provide status and to encourage additional commitments by consumers in step 340 and by buddies in step 347.

In step 360 the offer closes. It closes either because the maximum or minimum quantity has been met, or other preconditions have been satisfied or because the time limit has expired. The resolution of preconditions is done in step 365, this is preferably a simple process of simply tallying up commitments and comparing them to supplier specified minimum order. Alternatively, this step can be more complex if the consumer is permitted to attach his or her own preconditions to the listed transaction. The mediator in step 250 would then need to consider whether consumers' condition has been accepted by the supplier or suppliers. In addition, such a condition may impact the supplier's price, in which case a number of these conditions would need to be grouped separately from other commitments. Commitments in this separate group and commitments of consumers not having preconditions are then tallied separately to determine if the prerequisite minimum quantity is reached.

If the preconditions are met in step 370, the supplier or seller receives, in step 375, consumer shipping and payment information from the web based medium. This step may also be facilitated by the mediator in step 250 (FIG. 2). The seller then ships the goods in step 385 or otherwise completes the transaction with the committed parties for consideration that has been agreed upon by the parties. If the preconditions are not met, step 365, all parties are notified that the preconditions have not been met and that the transaction will not be moving forward 380.

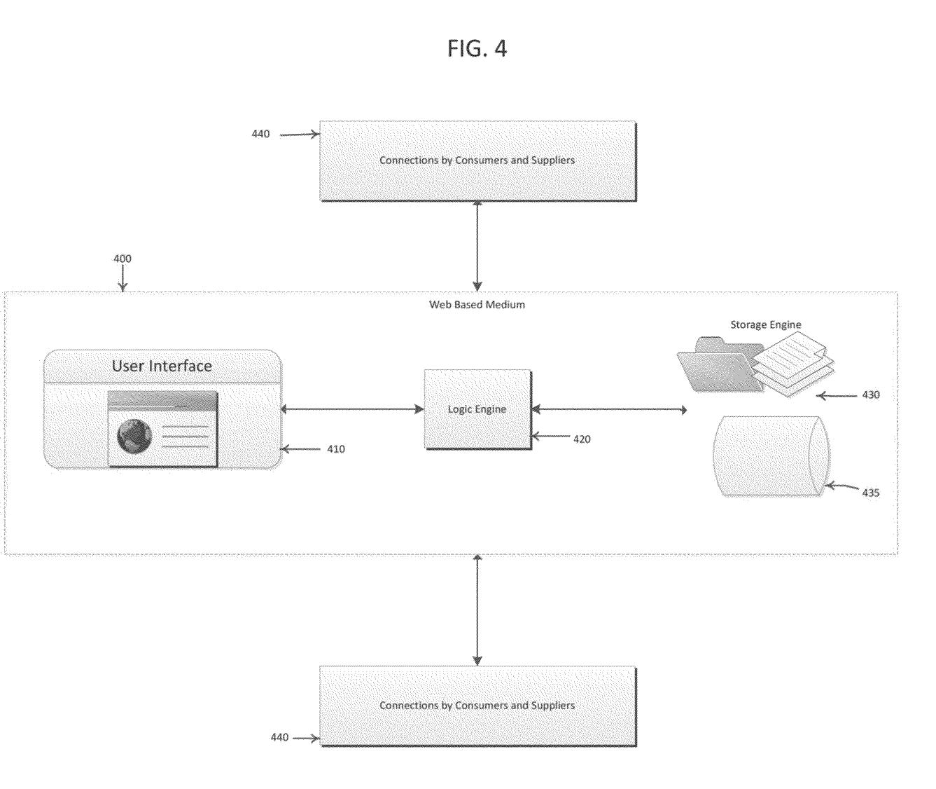

FIG. 4 describes the preferred embodiment of the web based medium which is anchored by the transactional apparatus 400. The consumers and suppliers 440 connect to the transactional apparatus 400 using the world wide web, also referred to as the internet. Internet, however, need not be the only enabling access mechanism. For example, the transactional mechanism can have a traditional brick and mortar presence on main street, with consumers and suppliers requesting transactions or listing transactions by actually visiting their local branch.

The transactional apparatus 400 is preferably comprised of the user interface 410, the logic engine 420 and the storage engine 430. The user interface 430 may be dynamically adaptable to at least two types of users, such as, but not limited to a consumer and a supplier, a buyer and a seller, a lessor and lessee, or a renter or a land owner. Preferably, the user interface may be dynamically adaptable to the needs of other types of users, the most significant of these being the mediator user. This adaptation feature is most clearly demonstrated when different functions and utilities are made available to one type of user but not to the other. The logic engine 420 drives this adaptation after the user identifies him or herself during registration. In a more sophisticated embodiment, the logic engine 420 may deduce the user type by monitoring the user's activity while the user is logged into the transactional apparatus 400.

The logic engine 420 provides the computer logic which enables the technological environment of the present invention. The logic engine 420, provides users with an ability to search for pending or desired transaction and to request or list their own transaction. It also enables the consumers and supplies to negotiate with one another.

The storage engine 430 provides data storage for the present invention. It is preferable that the storage engine 430 manage a commercially available database product 435 that can easily manage and store large numbers of individual records. These records are retrieved using queries built by the storage engine 430 in response to requests from the logic engine 420. The database 435 is preferably used to store user accounts, proposed and ongoing transactions, including all attributes of these transactions, such as preconditions. The database 435 may also be utilized to store product descriptions and conversations between various users of the transactional apparatus 400.

The transactional apparatus 400 may be assembled using existing software products or individual modules. It may also be written using programming techniques and languages well known in the art. The transactional apparatus software may be able to run on widely available commercial or consumer hardware, or may require proprietary hardware.

The purpose of this transactional apparatus 400 is to collect, organize, and control the data necessary to allow proper operational functionality between the other elements. All information and data entered by users and sellers via their respective portals is stored, analyzed, and processed by this element. The transactional apparatus 400 handles all internal connectivity and data delivery functionalities of the present invention. In doing so, the transactional apparatus 400 may be using application programming interface of a commercially available application framework, such as, but not limited to WebSphere®, WebLogic® or .Net®, or it may provide it's own proprietary utilities to achieve the same functionality The web based “back-end” software and hardware infrastructure may consist of any number of necessary computer server systems and computer network components necessary for IP connectivity, any pre-existing software applications or custom applications necessary to ensure the proper functioning of the business method and/or process and its elements. The web based “back-end” software and hardware infrastructure can include any variation of hardware and software necessary to best achieve the proper functioning of the method and/or process.

The technologies discussed, especially the user interface 410, can be implemented on commercial computer servers, desktops, laptops and mobile devices, such as phones, tablet PCs and personal digital assistants. The user interface 410 may run on any device having an internet browser, such as Internet Explorer®, while the data processing backend may run on any system having an operating system and central processing unit that are compatible with application code that enables the present invention. These concepts will be easily appreciated by those skilled in the art.

The following is a brief description of one scenario of how the present invention may function on the web based medium 400. When a user registers in step 210 or 260 (FIG. 2), the registration is processed by the logic engine 420 and then stored in the database 435 by the database engine 430. The user then searches for or transaction or submits a request for a desired transaction using widgets and links presented by the user interface 410. These widgets, produce actionable events that the logic engine 420 may interpret to be, for example, either searches or transactions. The logic engine 420, would then initiate a mediator process to validate the proposed transaction, and upon successful validation will seek bids from suppliers in steps 130 (FIG. 1) or step 320 (FIG. 3). The mediator 250 (FIG. 2) would search the database 435 for registered sellers who would be the best candidates to receive such bid offers. If the mediator is human, the logic engine 420 would present a user interface 410 containing consumer and supplier information and transactional data to such a human mediator, and would then act on commands and other events initiated by the mediator to promote the transaction and execution and delivery of transacted goods or services.

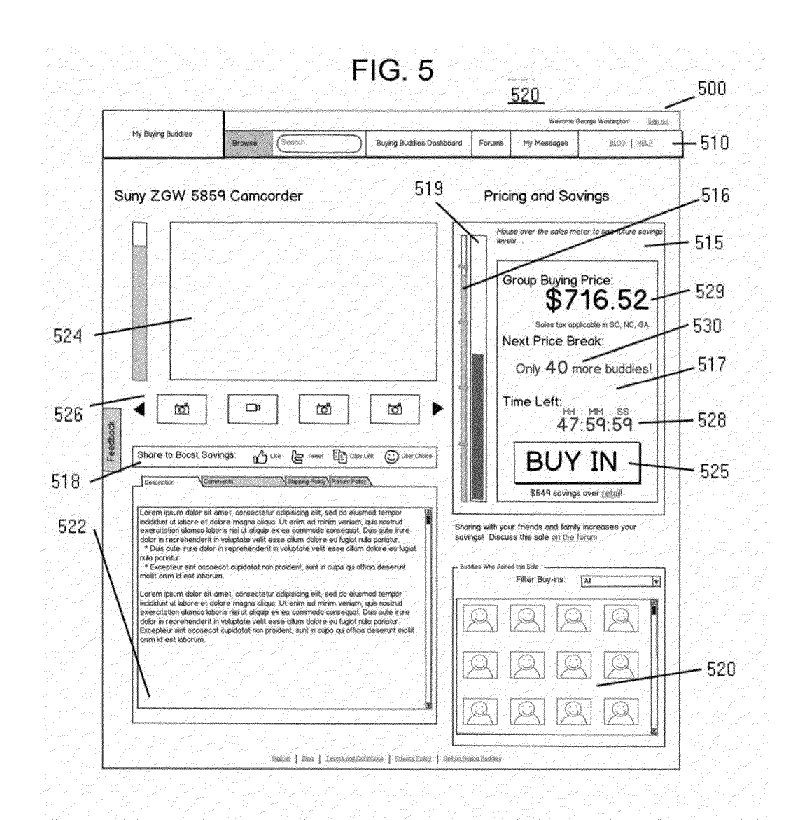

FIG. 5 and later figures represents an embodiment of the user interface 410. The user interface 410 may be presented in many forms and styles and may by supported by a variety of technological platforms. Shown in FIG. 5 is the window 500, the action bar 510, the price indicator 515. the price indicator meter 516, the target indicator meter 519, the indicator detail window 517, the buddy list 520, the description window 524, the action key 525, the product list 526, the interface bar 518, and the discussion board 522. The window 500 is part of the technological environment tailored to the needs of at least one consumer.

The price indicator 515 is one of the main volume utilities, which are tools intended to increase transactional volume. It shows to the consumer whether additional commitments are required. The indicator detail window 517 is showing the current transaction for which the bid has been received (step 130 of FIG. 1), or which is going to be proposed for bidding (step 105 of FIG. 1). Here the consumer may be participating in at least one transaction. Other transactions can be displayed by scrolling the list of active transaction using the indicator detail window 517.

The indicator detail window 517 is able to show a plurality of detailed information for the particular transaction. Information is intended to provide status and to encourage greater consumer participation. The type of information displayed in the indicator detail window 517 may be, but is not limited to the current price per product or service 529, the time remaining in the transaction 528, the action key 525 and a motivating expression 530. This information can differ and may be displayed in a variety of ways.

The price indicator meter 516, also known as the graphic indicator, is the visual representation of the price at the requested level of commitments, whereas the target indicator meter 519 displays the actual price at the present level of commitments. In a different embodiment the price indicator meter 516 may indicate the current price, while the target indicator meter 519 may represent unexpired time. The consumer utilizes the action key 525 to express commitment or to voice his or her interest in the transaction.

The price indicator meter 516 may be dynamic or discreet or both. A dynamic price indicator is sensitive to the slightest change in the number of commitments or interested consumers. Each new commitment may be reflected by an advancement of the indicator meter bar no matter how slight or pronounced is the change. Such real time progression may be especially helpful in small lots, and may motivate more consumers or buddies to commit than if a discreet indicator is used. However, in especially high volume transactions, or those involving large quantities, a dynamic price indicator may not be very practical, as each new commitment or transaction may have a truly miniscule impact on the overall progression of the target indicator meter 519. In such a case it may be better to use a discreet price indicator, where the target indicator meter 519 only changes when the level of commitments reaches the next predetermined milestone. It may be up to mediator step 250 (FIG. 2) of the logic engine 420 to determine which type of price indicator meter 515 should be used for any particular transaction. The meter type may also be specified by the consumer or supplier as a secondary prerequisite condition, or it may be chosen by a human mediator.

The description window 524 describes the product or service that is displayed by the indicator detail window 517. The description may be procured by the mediator from an independent third party so as to be impartial. Alternatively, consumers may be permitted to embellish the description to make it more appealing to other consumers. The product list 526 displays similar products to the one currently presented in the description window 524. It may also be a list of all transactions which interest this consumer, or it may be list transactions proposed by the mediator in response to the consumer's expressed interest or commitment.

The interface bar 518, the buddy list 520, and the discussion board 522 are all volume generating tools provided to the consumer to increase the level of commitments. The consumer will first suggest the transaction to his buddy list 520. The buddy list 520 preferably lists all consumers or users of the web based medium who have previously participated in consumer's transactions. Alternatively, the buddy list 520 displays participating consumers, while a separate function in the action bar 510 enables the consumer to invite additional consumers. The consumer's group may contain consumers that were suggested, by the mediator in step 250, or determined by the logic engine 420, based on views and interests that are similar to those of the consumer. The consumer may also reach out to buddies on various social interne portals using the interface bar 518.

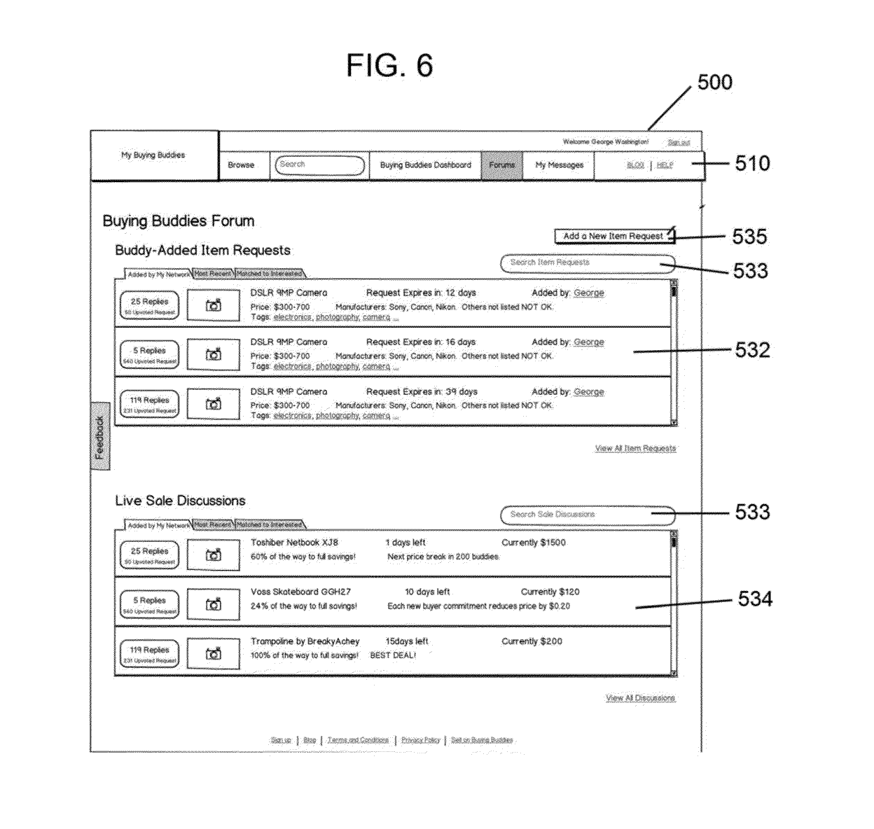

FIG. 6 demonstrates how a mediator may utilize the transactional apparatus 400 (FIG. 4) to try to obtain a successful finally for a seemingly faltering transaction or to opportunistically promote previously submitted transactions. The screen 500 shown in FIG. 6 may be presented to both consumers and suppliers. The item request window 532 displays all transactions that may not be generating enough interest or which may soon expire without having satisfied seller's preconditions. The mediator may display this window to new consumers or those searching for possible transactions. Similarly the supplier listed transactions 534 present seller or supplier listed transactions to consumers. The consumer or supplier may utilize the search field 533 to identify similar transactions or to add new requests or listings using the add transaction widget 535.

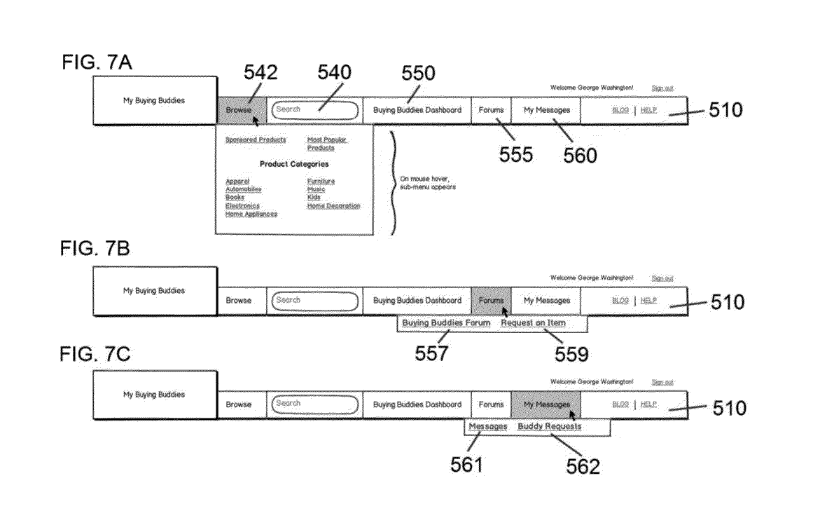

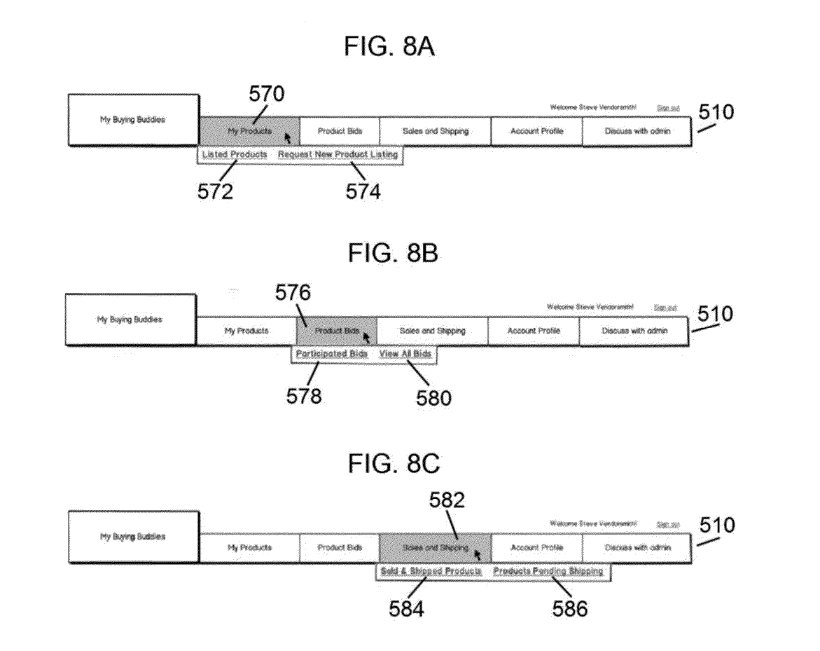

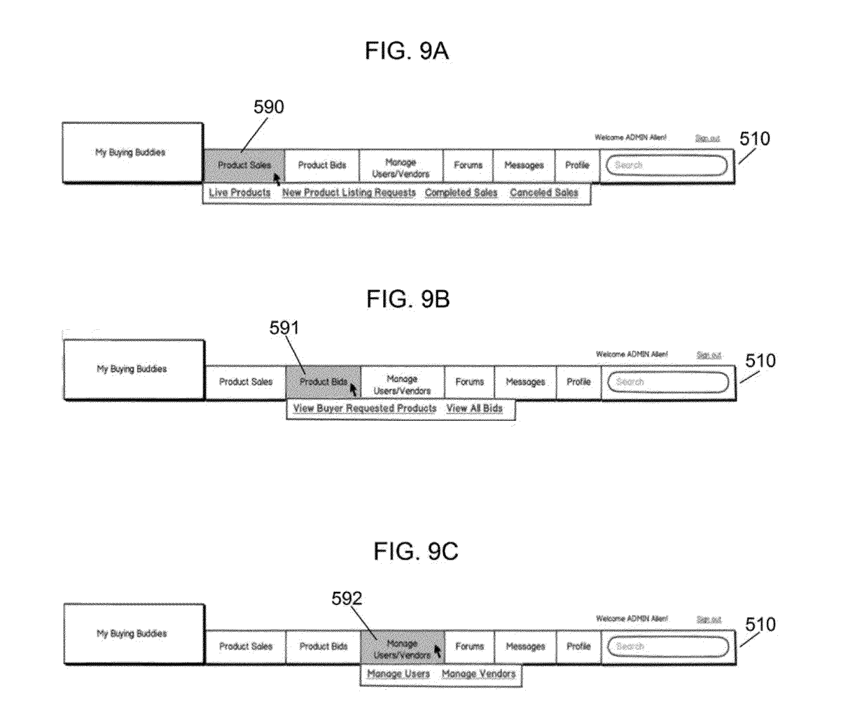

The transaction engine 420 provides a technological environment that can dynamically modified to provide the right tools to at least two or more types of users. This can be seen in FIGS. 7A-7C, 8A-8C and 9A-9C. FIG. 7A-7C is the action bar 510 that is shown to a consumer type user. It provides the consumer with an ability to browse current transactions 542, search for transactions 540, reach out to buddies 550, enter forums 555 to discuss and promote transactions and to send and receive messages 560. Each selection in the action bar 510 provides more specific choices that are also geared to this specific user type, like sub forums 557 and 559 of the forum item 555 and message type sub items 561 and 562 of the messages item 560. Similarly, FIGS. 9A-9C demonstrate the action bar 510 provided to the administrative user or mediator, while FIGS. 8A-8C represent the action bar 510 used by the suppliers. The difference is that the mediator user can view sales 590, view bids 591, or manage users/vendors or suppliers 592, while the supplier can view products 570, bids 576 and final transactions 582. Meaning, each type of a user is provided with the technological environment specifically geared to his or her needs, without any superfluous functionality.

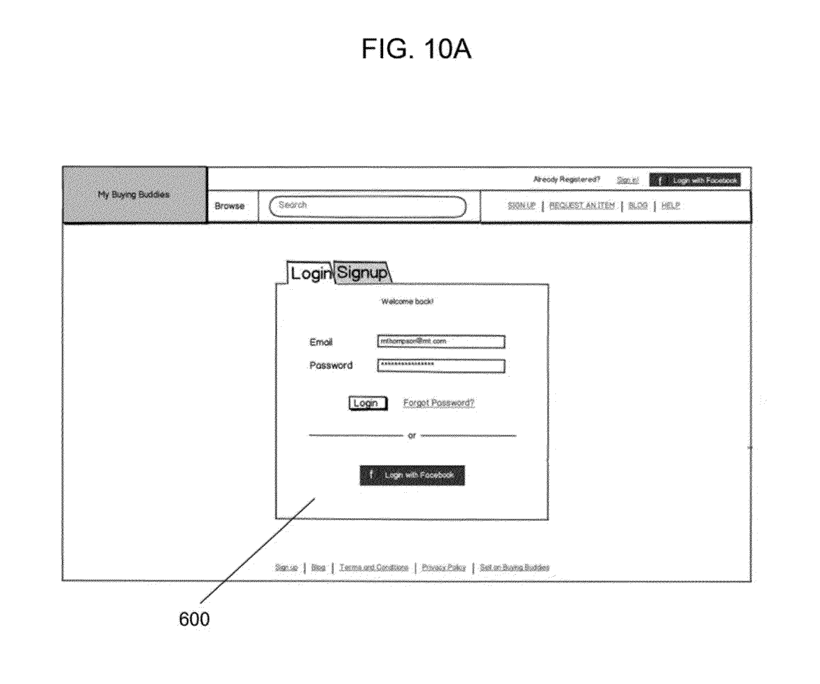

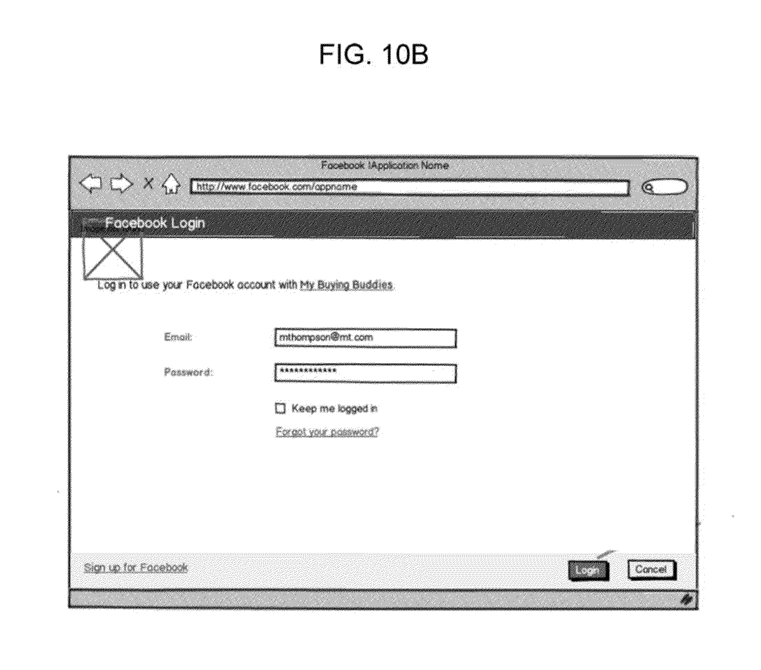

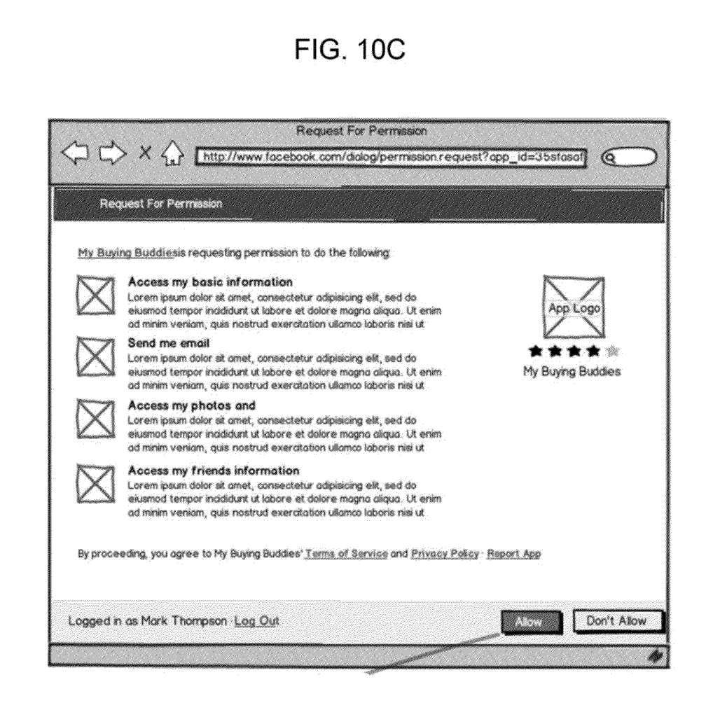

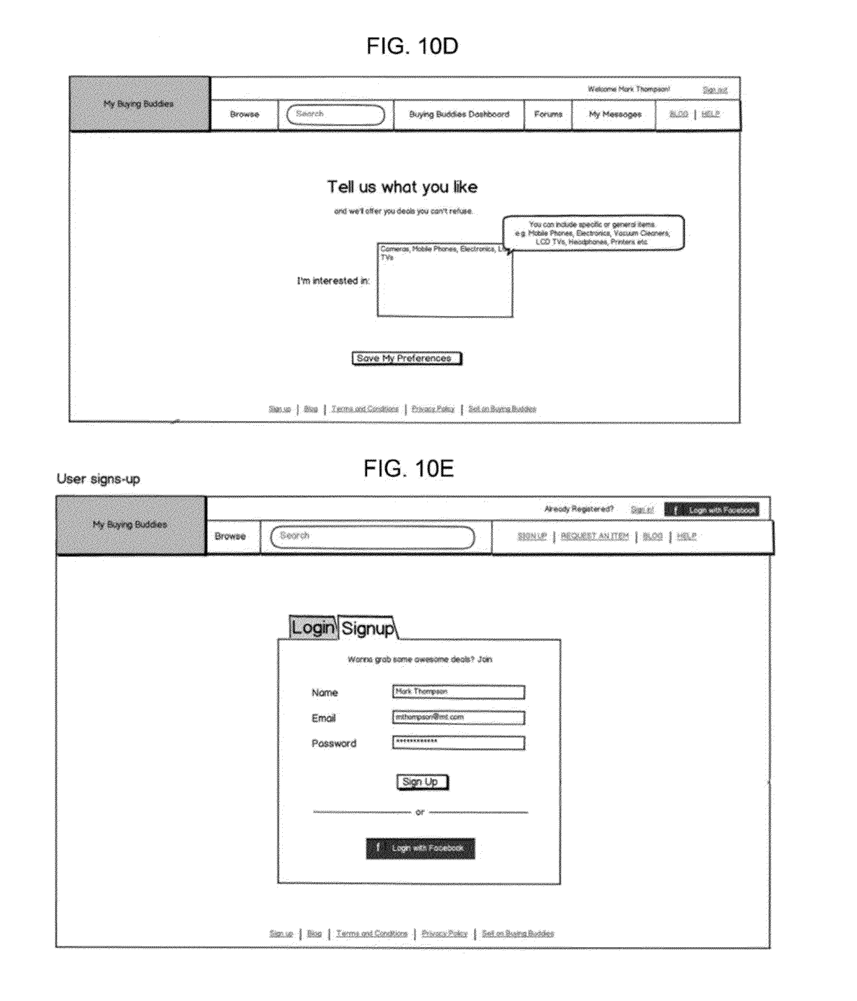

FIGS. 10A-10E demonstrate the functionality behind the interfacing bar 518 (FIG. 5). Those skilled in the art will appreciate that the steps described in these figures represents one embodiment of this functionality and other methods may be used to achieve interconnection between the web based medium of the present invention and Internet based social web sites. In FIG. 10A, the user interface 410 presents the standard login or registration screen 600. The user can separately log into a web site in FIG. 10B. Alternatively, the interfacing bar 518 will open the login screen for the social web site as shown in FIG. 10B. A utility provided by the logic engine 420 (FIG. 4) is then launched requesting the user, either a consumer or a supplier, for access to authentication information of that social website FIG. 10C. Once granted, the user is brought back to the user interface 410 in FIG. 10D. User's authorization provides the logic engine 420 with access to user login information such as cookies and certificates. Possessing those, the transaction apparatus 400 can masquerade as the user to reach the user's list of friends or buddies.

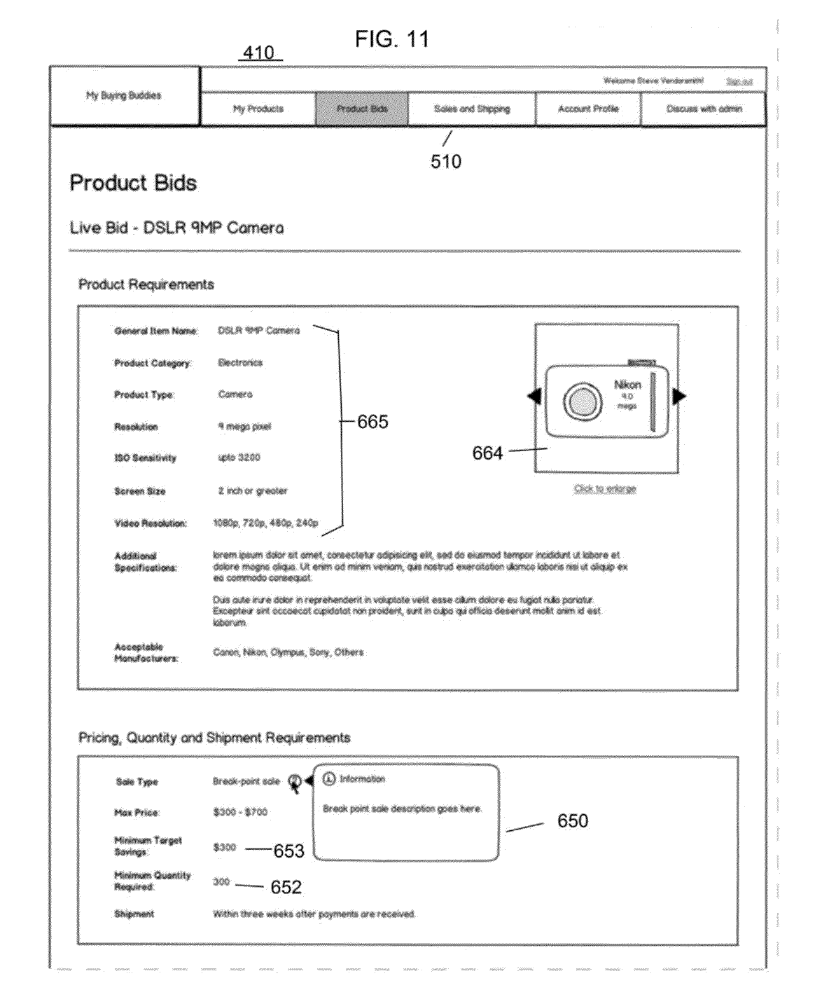

FIG. 11 presents an embodiment of the user interface 410 geared toward a supplier or a seller. In this case the supplier would like to list to product displayed in the product window 664. The supplier is able to add the product description 665. Alternatively, the description can be sourced in by the logic engine 420, or the mediator step 220, and appear automatically as soon as the product is selected. Once the product is selected, the supplier can then set the prerequisite conditions governing this transaction. In this case the supplier selected the minimum lot of orders 652 at a certain price term per unit 653. The seller may have the discretion to set his or her own preconditions, or these can be governed by rigid rules, with the seller receiving a set of permitted preconditions.

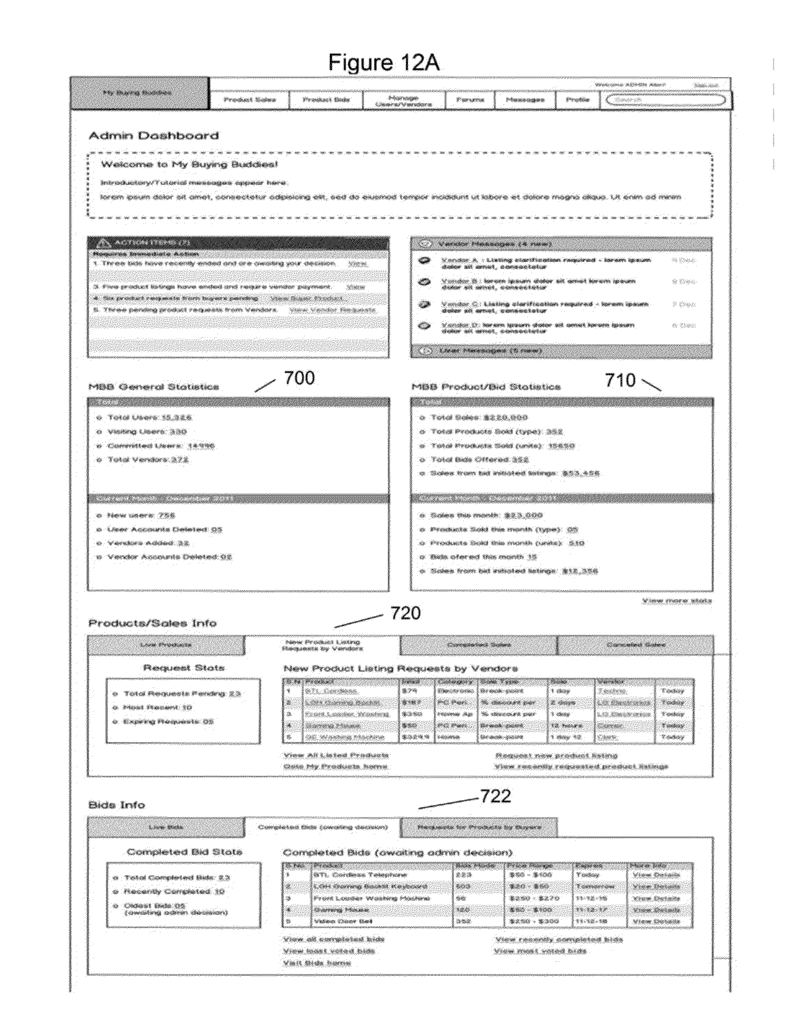

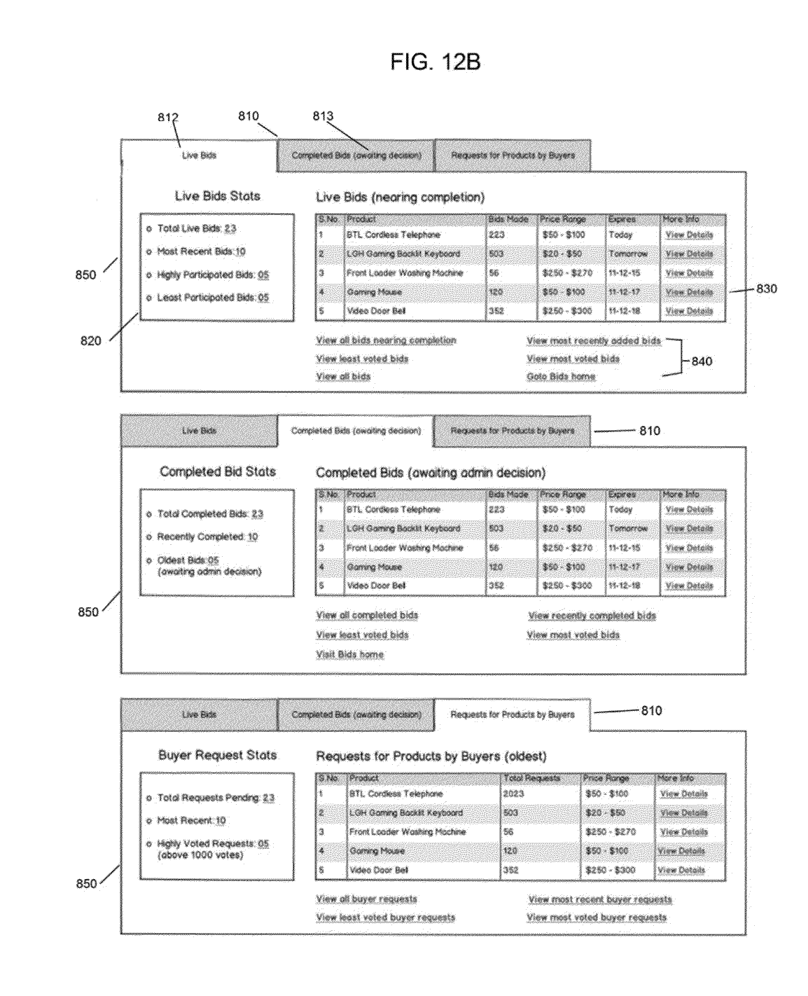

In case of a human mediator, the mediator step is done with the help of the user interface 410 as shown in FIG. 12A. The transactional apparatus 400 supplies a human mediator with tools that permit the mediator to monitor activities of consumers and suppliers and to determine which transactions are live and which are about to fall through. Shown is the decision window 700. This lists all matters requiring mediator's decision or input. These may include, pending final transactions, submitted bids by sellers, and new transaction requests awaiting approval. Windows 720 on the bottom of the screen list ongoing transactions and provide tools to cancel, promote or correct the listed transactions. In bottom most pane 722 the mediator is able to monitor and control the bid process and to ensure that completed or expired transactions are quickly and efficiently settled and cleared. Even in cases of human mediator the actual linking of consuming and supplying transactions may be achieved through an automated computer module provided by the transactional engine 420. The linking discussed pertains to identifying compatible transactions, or offers to transact, which are most likely to succeed and become final or finalized transactions.

FIG. 12B is a further illustration of tools provided to a mediator. For optimal efficiency, the mediator may be able to choose which panes 850 should appear on the screen and each pane may be highly customizable. Each pane contains tabs 810, which help the mediator switch quickly between critical screens, such as ongoing bids 812 and completed bids 813. The mediator may be able to quickly add additional tabs 810 or customize existing ones. Each pane 850 may contains at-a-glance live statistics 820, which reflect the pace of activities listed in table 830. Each of the activities in a table 830 may be expandable to show details, which may be further editable. An administrator may be able to intervene in any activity listed in 830 by either expanding it to show more details or by using commands in the action console 840.

### SUMMARY

Within the web based medium, a seller, otherwise known as supplier, will have access to current offerings, ability to scan offerings, submit requests for products the buyer would like to see offered, and other account information, such as payment options and information, account funding options, order history, accepted offerings status, ability to send offering information to non-members, customer support contact information, as well as other information that may be necessary for the buyer's interface to allow proper conceptual functioning.

The Buyer's Internet Based Portal is the web based interface that buyers will use to interface with the other elements. It will contain whichever graphical interfaces that are necessary for proper functioning with the other elements, and will be fully integrated into the web based “back-end” element.

Within web based medium, the seller will have access to items for which buyers, otherwise known as consumers, have shown an interest. Seller will be able to compete with other sellers in order to become the chosen supplier for a particular offering by submitting selling prices and quantity levels for those prices. The information provided to the seller about each offering will include the bid due date, the length of the offering (typically 48 hrs), and minimum quantity. In addition to being able to browse and bid on existing offers, sellers will be able to initiate an offering by submitting a particular item for sale, with pricing for each level of quantity. Such seller initiated offerings will then become available for acceptance by the buyers community. Other information available to seller within this portal include account information, such as payment receipt and information, pending offerings and bids, items sold and orders which seller must fulfill, customer support contact information, as well as other information that may be necessary for the sellers' interface to allow proper conceptual functioning.

The Seller's Internet Based Portal is the web based interface that sellers will use to interface with the other elements. It will contain whichever graphical interfaces that are necessary for proper functioning with the other elements, and will be fully integrated into the web based “back-end” element.

The main elements are connected logically through the web based “back-end” element, and physically via various LAN and \VAN computer network infrastructure and connections.

The actual functioning and processes of the business method that be varied in any manner of degrees necessary to best achieve the overall purpose of the method. For example, the conceptual process flows outlined in FIGS. 1-4 and be varied in a number of ways in order to achieve the same desired end result, which is the stated purpose of this business method. Similarly, there are no fixed requirements for hardware and software involved for any of the elements in order for the desired benefit and functioning of this method to be achieved.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method of realizing volume savings comprising the steps of:
registering at least one consumer and at least one supplier in a web based medium;
providing a technological environment within said web based medium to each at least one consumer and each at least one supplier; said technological environment customized to perform at least one consumer task or at least one supplier task;
said at least one consumer capable of expressing an interest to enter into at least one consumer transaction using said technological environment, said at least one consumer transaction subject to at least one prerequisite condition;
said at least one supplier capable of listing at least one supplying transaction using said technological environment, said at least one supplying transaction subject to a prerequisite minimum quantity condition; and
a mediator step, said mediator facilitating success of said consuming transaction or said supplying transaction.

2. The method of claim 1, further comprising the step of setting a time limit on duration of said at least one consuming transaction or said at least on supplying transaction.

3. The method of claim 1, further comprising the step of said at least one consumer inviting said at least one buddy to participate in said at least one transaction, wherein said at least one consumer is capable of interfacing with said at least one buddy, wherein said at least one buddy is not a registered consumer in said web based medium.

4. The method of claim 3, further comprising the steps of inviting said at least one buddy to participate in said at least one transaction, wherein said invitation step is suggested at said mediator step; and
said at least one buddy registering as a consumer on said web based medium.

5. The method of claim 1, wherein the step of setting said at least one prerequisite condition for said at least one consumer transaction or said at least one supplying transaction, wherein said at least one prerequisite condition is included in a group comprising a maximum price, a quantity factor, a method of payment, a transaction term, a delivery term, a transaction type, a secondary factor or any combination thereof.

6. The method of claim 1, further comprising the steps of said at least one supplier submitting a bid on said least one consumer transaction;
said at least one supplier submits a bid on said at least one consuming transaction, said bid being within an acceptable range of deviation from said at least one prerequisite condition;
wherein said mediator step is selecting a first said bid, said bid is fulfilling one of the said at least one prerequisite conditions; and
said mediator step selecting at least one other said bid, wherein said one other bid fulfills another of the said at least one prerequisite conditions.

7. The method of claim 1, further comprising the steps of:
said at least one consumer committing to said at least one supplying transaction;
said at least one consumer encouraging said at least one buddy to commit to said at least one supplying transaction;
said web based medium encouraging commitments to said at least one consumer transaction or said at least one supplier transaction by displaying a graphic indicator; and
the step of determining which graphic indicator to display to said at least one consumer or said at least one supplier, wherein said graphic indicator is made up of a group comprising a dynamic indicator or a discreet price indicator.

8. The method of claim 1, wherein the mediator step further comprises a step of linking said consuming transaction with said supplying transaction using an automated computer module.

9. The method of claim 1, further comprising the steps of detecting an invalid transaction from said consumer transaction or said supplying transaction;
advising said at least one consumer or said at least one supplier on whether said at least one consuming transaction or said at least one supplying transaction is likely to be completed; and
approving said consumer transaction or said supplier transaction, wherein said steps are accomplished by said mediator step

10. The method of claim 1, wherein the mediator step further comprises a step of linking said consuming transaction with said supplying transaction using a human operator.

11. The method of claim 2, further comprising the step of said mediator step actively promoting said at least one consumer transaction or said at least one supplier transaction.

12. A method of realizing volume savings comprising the steps of:
registering at least one consumer and at least one supplier in a web based medium;
organizing a plurality of said at least one consumers into a consumer group; providing a technological environment within said web based medium to each at least one consumer and each at least one supplier; said technological environment customized to perform at least one consumer task or at least one supplier task;
said at least one consumer capable of expressing an interest to enter into at least one consumer transaction on behalf of said consumer group, wherein said at least one consumer transaction subject to at least one prerequisite condition;
said at least one supplier capable of listing at least one supplying transaction using said technological environment, said at least one supplying transaction subject to a prerequisite minimum quantity condition; and
a mediator step.

13. The method of claim 12, further comprising the step of setting a time limit on duration of said at least one consuming transaction or said at least on supplying transaction.

14. The method of claim 13, further comprising the steps of at least one consumer expressing a commitment to said at least one consumer transaction or to said at least one supplier transaction; and
said at least one consumer inviting said at least one buddy to join said consumer group.

15. The method of claim 12, further comprising the step of said consumer group committing to said at least one consumer transaction or to said at least one supplier transaction.

16. The method of claim 12, further comprising the steps of said at least one supplier submitting a bid on said at least one consuming transaction;
said mediator step selecting said bid as one of winning bids, said bid is fulfilling one of the said at least one prerequisite conditions; and
said mediator step selecting at least one other bid as another one of winning bids, wherein said at least one other bid is fulfilling another of the said at least one prerequisite conditions.

17. The method of claim 12, wherein said mediator step activates an automated engine within said web based medium, said automated engine directing said at least one consumer to a transaction, said transaction being similar to said at least one consumer transaction.

18. A transactional apparatus comprising,
a user interface, said user interface dynamically adaptable to at least two types of users, wherein said two types of users utilize said user interface to express a wish to enter into an at least one transaction;
a logic engine, said logic engine capable of tracking a plurality of transactional activities of said at least two types of users, said logic engine matching said at least two types of users based on a plurality of compatibility factors, and said logic engine capable of recording a commitment to enter into said at least one transaction by said at least two types of users; and
a storage engine, said storage engine capable of a relational recording of said at least two types of users, wherein said relational recording is grouped by said user types, by said compatibility factors, and by said commitments.

19. The transactional apparatus of claim 18, wherein said user interface further comprises volume utilities, wherein said volume utilities are capable of increasing the size of said volume transaction.

20. The transactional apparatus of claim 18, further comprising a mediator user, wherein said interface contains user screens for use by said mediator user, said mediator user screens granting control features over said at least two users and over said at least one transaction to said mediator user.

21. The transactional apparatus of claim 18, further comprising a mediator, wherein said mediator is an automated software module, said mediator having control over said at least two users and over said at least one transaction.
